(19) United States
(12) Patent Application Publication
(10) Pub. No.: US 2007/0026172 A1
(43) Pub. Date: Feb. 1, 2007

(54) Fibre reinforced cement column and method of forming the same

(76) Inventors: James Gleeson, New South Wales (AU); Kevin Gibson, Queensland (AU); Michael Porfida, New South Wales (AU); Michael Hogan, New South Wales (AU)

Correspondence Address: GARDERE / JAMES HARDIE;GARDERE WYNNE SEWELL, LLP, 1601 ELM STREET, SUITE 3000, DALLAS, TX, 75201, US

(21) Appl. No.: 10/575,432

(22) PCT Filed: Oct. 8, 2004
(86) PCT No.: PCT/AU04/01378

§ 371 Date: Apr. 10, 2006

(30) Foreign Application Priority Data
Oct. 8, 2003 (AU) 2003905479

(51) Int. Cl. B28B 23/08; B29C 59/02; B24B 19/00

(52) U.S. Cl. 428/34.5; 264/293; 451/436

(57) ABSTRACT

A fibre reinforced cement (FRC) tubular body having a wall thickness to outer diameter ratio of less than around 0.050, preferably 0.035. A lathe assembly and method for forming an elongate tubular body, such as said FRC tubular body, is also claimed, said lathe assembly including: an elongate base (1); a pair of chucks (4) located at opposite longitudinal ends of said base (1), said chucks (4) being configured to engage opposite longitudinal ends of the tubular body; two or more lateral supports (11, 12, 17) connected to said base to support the tubular body at two or more support locations between its ends; drive means (8) for rotating the body about a longitudinal axis; and a profiling tool (9) connected to the base and engageable to machine or profile an outer circumferential surface of the tubular body.

This invention relates to the design and manufacture of tubular bodies such as columns or pipes. The invention has been developed primarily in relation to architectural columns manufactured from Fibre Reinforced Cement (FRC) and will be described hereinafter with reference to this application. However, it will be appreciated that the invention is not limited to this particular material or field of use.

### BACKGROUND OF THE INVENTION

The following discussion of the prior art is intended to place the invention in an appropriate technical context and to allow its significance to be properly appreciated. However, any references to the prior art should not be construed as admissions that such prior art is widely known or forms part of common general knowledge in the field.

Known methods of machining tubular columns have typically involved mounting the column on a lathe using a rotatable chuck at each end of the column. Once engaged by the chucks, a single support roller is brought into contact with the outer surface of the column to provide lateral support for the column during the machining process.

The outer circumference of the column is then machined to the desired profile using a machining head located opposite the support roller. Typically both the support roller and the machining head are mounted on a rail or slide extending along the length of the lathe. In this way, the machining head and the support roller can be driven progressively along the length of the column, machining the column as they move, and without moving out of relative alignment with one another.

This known method of forming tubular columns tends to work reasonably well with columns having relatively thick walls. However, the applicant has found that if thinner walled columns are profiled using the prior art method, the columns tend to vibrate excessively when rotated on the lathe, resulting in fracture or severe surface grooving of the columns during the machining process. This problem is particularly pertinent in the context of FRC columns and pipes. Consequently, such columns are required to be formed with wall thicknesses greater than the intended application would dictate in structural terms, which increases the requirement for raw materials, cost and weight, while compromising handlability.

It is an object of the present invention to overcome or ameliorate one or more of the disadvantages of the prior art, or at least to provide a useful alternative.

### DISCLOSURE OF THE INVENTION

A first aspect of the invention provides a Fibre Reinforced Cement tubular body having a wall thickness to outer diameter ratio of less than around 0.050.

Preferably, the body has a wall thickness to outer diameter ratio of less than around 0.045. More preferably, the body has a wall thickness to outer diameter ratio of less than around 0.035.

Preferably, an outer circumferential surface of the body is machined or profiled until the wall thickness to outer diameter ratio defined above is achieved.

More preferably, the body is profiled using a method including the steps of:

supporting the body at or adjacent its ends for rotation about a longitudinal axis;

supporting the body laterally at two or more lateral support locations between the ends;

rotating the body about the longitudinal axis; and

machining or profiling an outer surface of the body using a profiling tool.

Preferably, the tubular body is designed for use as an architectural column, but may alternatively be intended for use as a pipe, structural member, a concrete forming element or for some other purpose.

Preferably, the two or more lateral support locations are disposed at substantially the same position along the length of the column. More preferably, the two or more lateral support locations are spaced circumferentially around the column.

Alternatively, the two or more support locations may be located at different axial positions along the column. In this alternative embodiment, the support locations are preferably also spaced circumferentially around the column.

Preferably, the lateral support is provided by respective support rollers engageable with an outer circumferential surface of the column. The support rollers and the profiling tool are preferably adapted to move in unison along the length of the column during the profiling operation. Preferably, two of the support rollers are independently movable into engagement with the column. More preferably, three support rollers are provided, two of the support rollers being movable into engagement with the column independently of the third support roller. Even more preferably, two of the support rollers are dependently movable into engagement with the column.

Preferably, the dependently movable support rollers are hingedly mounted to opposite ends of a first bell crank having an axis of rotation substantially parallel to the longitudinal axis of the column. More preferably, the first bell crank is hingedly connected to one end of a second bell crank having an axis of rotation parallel to the longitudinal axis of the column.

Preferably, the other end of the second bell crank is rotatably connected to a first base plate. More preferably, the first base plate is longitudinally movable along the elongate base. Even more preferably, the first base plate is selectively fixedly connectable to the elongate base in any one of a plurality of axial locations. Preferably, the independently movable support roller is mounted to one end of a pivotal arm. More preferably, the arm has an axis of rotation parallel to the longitudinal axis of the column.

Preferably, the other end of the arm is hingedly connected to a second base plate. More preferably, the second base plate is longitudinally movable along the elongate base. Even more preferably, the second base plate is selectively fixably connectable to the elongate base in any one of a plurality of axial locations.

Preferably, the method includes the additional step of progressively moving the first and second base plates and the profiling tool simultaneously along the column during the profiling step.

Preferably, at least one of the support rollers is configured to move axially in response to imperfections in the outer circumferential surface of the column.

Preferably, the profiling tool when in use is located axially adjacent one of the lateral support locations.

Preferably, the FRC column to be profiled is a blank formed on a mandrel using a Hatschek process. The machining or profiling step is preferably used to substantially reduce the initial wall thickness and refine the surface finish of the blank to form the architectural column.

Preferably, the column has a wall thickness to outer diameter ratio of less than around 0.050. More preferably, the column has a wall thickness to outer diameter ratio of less than around 0.045. Even more preferably, the column has a wall thickness to outer diameter ratio of less than around 0.035.

Preferably, the column is profiled on a lathe assembly including:

an elongate base;

a pair of chucks located at opposite longitudinal ends of said base, said chucks being configured to engage opposite longitudinal ends of the column;

two or more lateral supports connected to said base to support the column at two or more support locations between its ends;

drive means for rotating the column about a longitudinal axis; and

a profiling tool connected to the base and engageable to machine or profile an outer circumferential surface of the column.

Preferably, the two or more lateral supports are located at substantially the same axial position along the length of the column relative to one another. More preferably, the supports are spaced circumferentially around the column.

Alternatively, the two or more supports are located at different points along the length of the column. More preferably, in this alternative embodiment, the support locations are also spaced circumferentially around the column.

Preferably, the lateral supports take the form of support rollers engageable with an outer circumferential surface of the column. Preferably, two of the support rollers are independently movable into engagement with the column. More preferably, three support rollers are provided, two of the support rollers being movable into engagement with the column independently of the third support roller. Even more preferably, two of the support rollers are dependently movable into engagement with the column.

Preferably, the dependently movable support rollers are hingedly mounted to opposite ends of a first bell crank lever having an axis of rotation substantially parallel to the longitudinal axis of the column. More preferably, the first lever is hingedly connected to one end of a second bell crank lever having an axis of rotation parallel to the longitudinal axis of the column.

Preferably, the other end of the second lever is rotatably connected to a first base plate. More preferably, the first base plate is longitudinally movable along the elongate base. Even more preferably, the first base plate is selectively fixedly connectable to the elongate base in any one of a plurality of axial locations. Preferably, a pneumatic actuator is operable on the second lever to move the respective rollers into and out of engagement with the column.

Preferably, the independently movable support roller is mounted to one end of a pivotal arm. More preferably, the arm has an axis of rotation parallel to the longitudinal axis of the column.

Preferably, the other end of the arm is hingedly connected to a second base plate. More preferably, the second base plate is longitudinally movable along the elongate base. Even more preferably, the second base plate is selectively fixably connectable to the elongate base in any one of a plurality of axial locations.

Preferably, a pneumatic actuator is operable on the arm to move the respective roller into and out of engagement with the column.

Preferably, at least one of the support rollers is configured to move radially in response to imperfections in the outer circumferential surface of the column.

Preferably, the profiling tool when in use is located axially adjacent one of the support locations. More preferably, the profiling tool is longitudinally movable along the elongate base. Even more preferably, the profiling tool is selectively fixedly connectable to the elongate base in any one of a plurality of axial locations.

In a preferred form, the profiling tool, first base plate and second base plate are interconnected such that they move substantially in unison along the rails, so as to remain in relative lateral alignment during profiling operation.

A second aspect of the invention provides a method of manufacturing an elongate tubular body, said method including the steps of:

supporting the body at or adjacent its ends for rotation about a longitudinal axis;

supporting the body laterally at two or more lateral support locations between the ends;

rotating the body about the longitudinal axis; and

machining or profiling an outer surface of the body using a profiling tool.

Preferably, the tubular body is designed for use as an architectural column, but may alternatively be intended for use as a pipe, structural member, a concrete forming element or for some other purpose.

Preferably, the two or more lateral support locations are disposed at substantially the same position along the length of the column. More preferably, the two or more lateral support locations are spaced circumferentially around the column.

Alternatively, the two or more support locations may be located at different axial positions along the column. In this alternative embodiment, the support locations are preferably also spaced circumferentially around the column.

Preferably, the lateral support is provided by respective support rollers engageable with an outer circumferential surface of the column. The support rollers and the profiling tool are preferably adapted to move in unison along the length of the column during the profiling operation. Preferably, two of the support rollers are independently movable into engagement with the column. More preferably, three support rollers are provided, two of the support rollers being movable into engagement with the column independently of the third support roller. Even more preferably, two of the support rollers are dependently movable into engagement with the column.

Preferably, the dependently movable support rollers are hingedly mounted to opposite ends of a first bell crank having an axis of rotation substantially parallel to the longitudinal axis of the column. More preferably, the first bell crank is hingedly connected to one end of a second bell crank having an axis of rotation parallel to the longitudinal axis of the column.

Preferably, the other end of the second bell crank is rotatably connected to a first base plate. More preferably, the first base plate is longitudinally movable along the elongate base. Even more preferably, the first base plate is selectively fixedly connectable to the elongate base in any one of a plurality of axial locations. Preferably, the independently movable support roller is mounted to one end of a pivotal arm. More preferably, the arm has an axis of rotation parallel to the longitudinal axis of the column.

Preferably, the other end of the arm is hingedly connected to a second base plate. More preferably, the second base plate is longitudinally movable along the elongate base. Even more preferably, the second base plate is selectively fixably connectable to the elongate base in any one of a plurality of axial locations.

Preferably, the method includes the additional step of progressively moving the first and second base plates and the profiling tool simultaneously along the column during the profiling step.

Preferably, at least one of the support rollers is configured to move axially in response to imperfections in the outer circumferential surface of the column.

Preferably, the profiling tool when in use is located axially adjacent one of the lateral support locations.

Preferably, the column is formed of Fibre Reinforced Cement (FRC). Preferably, the FRC column to be profiled is a blank formed on a mandrel using a Hatschek process. The machining or profiling step is preferably used to substantially reduce the initial wall thickness and refine the surface finish of the blank to form the architectural column.

Preferably, the column has a wall thickness to outer diameter ratio of less than around 0.050. More preferably, the column has a wall thickness to outer diameter ratio of less than around 0.045. Even more preferably, the column has a wall thickness to outer diameter ratio of less than around 0.035.

According to a third aspect, the invention provides a lathe assembly for forming an elongate tubular body, said lathe assembly including:

an elongate base;

a pair of chucks located at opposite longitudinal ends of said base, said chucks being configured to engage opposite longitudinal ends of the tubular body;

two or more lateral supports connected to said base to support the tubular body at two or more support locations between its ends;

drive means for rotating the body about a longitudinal axis; and

a profiling tool connected to the base and engageable to machine or profile an outer circumferential surface of the tubular body.

Preferably, the tubular body is an architectural column, but may alternatively be intended for use as a pipe, a structural member, a concrete forming element or for some other purpose.

Preferably, the two or more lateral supports are located at substantially the same axial position along the length of the column relative to one another. More preferably, the supports are spaced circumferentially around the column.

Alternatively, the two or more supports are located at different points along the length of the column. More preferably, in this alternative embodiment, the support locations are also spaced circumferentially around the column.

Preferably, the lateral supports take the form of support rollers engageable with an outer circumferential surface of the column. Preferably, two of the support rollers are independently movable into engagement with the column. More preferably, three support rollers are provided, two of the support rollers being movable into engagement with the column independently of the third support roller. Even more preferably, two of the support rollers are dependently movable into engagement with the column.

Preferably, the dependently movable support rollers are hingedly mounted to opposite ends of a first bell crank lever having an axis of rotation substantially parallel to the longitudinal axis of the column. More preferably, the first lever is hingedly connected to one end of a second bell crank lever having an axis of rotation parallel to the longitudinal axis of the column.

Preferably, the other end of the second lever is rotatably connected to a first base plate. More preferably, the first base plate is longitudinally movable along the elongate base. Even more preferably, the first base plate is selectively fixedly connectable to the elongate base in any one of a plurality of axial locations. Preferably, a pneumatic actuator is operable on the second lever to move the respective rollers into and out of engagement with the column.

Preferably, the independently movable support roller is mounted to one end of a pivotal arm. More preferably, the arm has an axis of rotation parallel to the longitudinal axis of the column.

Preferably, the other end of the arm is hingedly connected to a second base plate. More preferably, the second base plate is longitudinally movable along the elongate base. Even more preferably, the second base plate is selectively fixably connectable to the elongate base in any one of a plurality of axial locations.

Preferably, a pneumatic actuator is operable on the arm to move the respective roller into and out of engagement with the column.

Preferably, at least one of the support rollers is configured to move radially in response to imperfections in the outer circumferential surface of the column.

Preferably, the profiling tool when in use is located axially adjacent one of the support locations. More preferably, the profiling tool is longitudinally movable along the elongate base. Even more preferably, the profiling tool is selectively fixedly connectable to the elongate base in any one of a plurality of axial locations.

In a preferred form, the profiling tool, first base plate and second base plate are interconnected such that they move substantially in unison along the rails, so as to remain in relative lateral aligrnent during profiling operation.

Preferably, the column is formed of Fibre Reinforced Cement.

### BRIEF DESCRIPTION OF THE DRAWINGS

A preferred embodiment of the invention will now be described, by way of example only, with reference to the accompanying drawings in which:

FIG. 1 is a perspective view of a lathe assembly according to one aspect of the invention, shown in use;

FIG. 2 is a side elevation of the lathe assembly of FIG. 1;

FIG. 3 is a cross-sectional view of the lathe assembly of taken on line 3-3 FIG. 2;

FIG. 4 is a schematic view of a “Classic” shaped column formed on the profiling assembly of FIG. 1;

FIG. 5 is a schematic view of a “Tapered” shaped column formed on the profiling assembly of FIG. 1;

FIG. 6 is a schematic sectional side elevation of an unfilled load bearing column;

FIG. 7 is a sectional plan view taken along line 7-7 of FIG. 6

FIG. 8 is a schematic sectional side elevation of a filled load bearing column in a pinned base arrangement;

FIG. 9 is a schematic sectional side elevation of a filled load bearing column in a fixed base arrangement

FIG. 10 is a plan view of an unfilled load bearing column with a handrail; and

FIG. 11 is a side elevation of the column of FIG. 10.

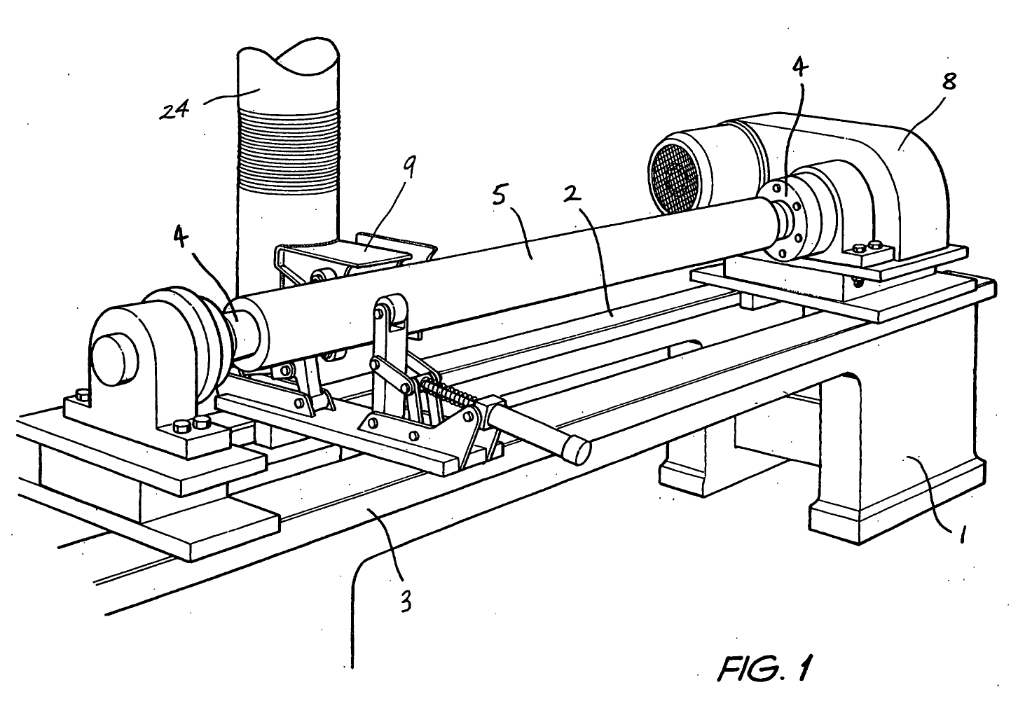

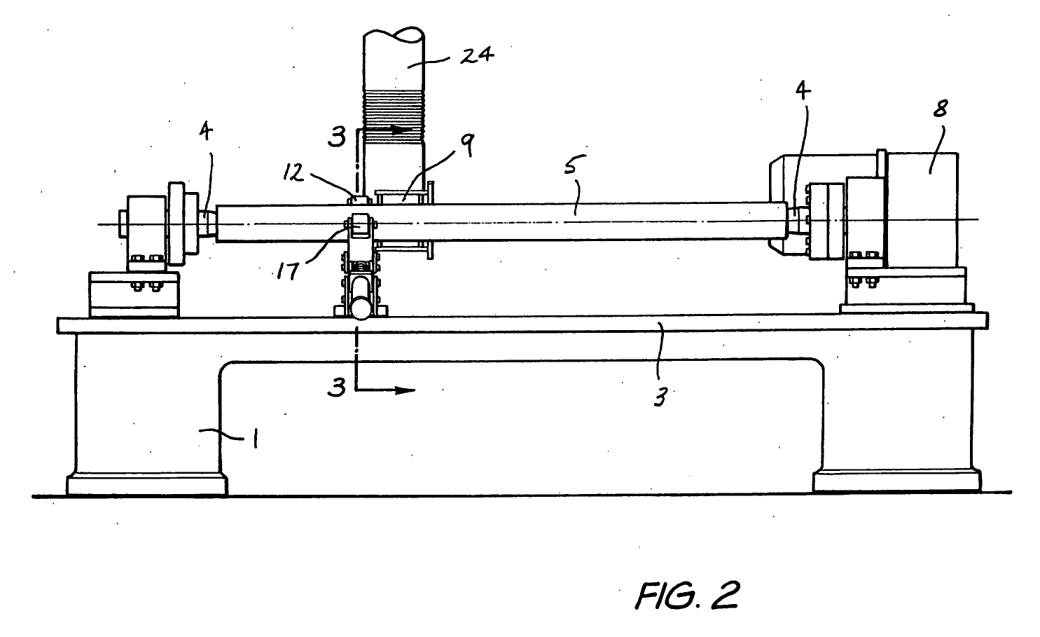

### PREFERRED EMBODIMENTS OF THE INVENTION

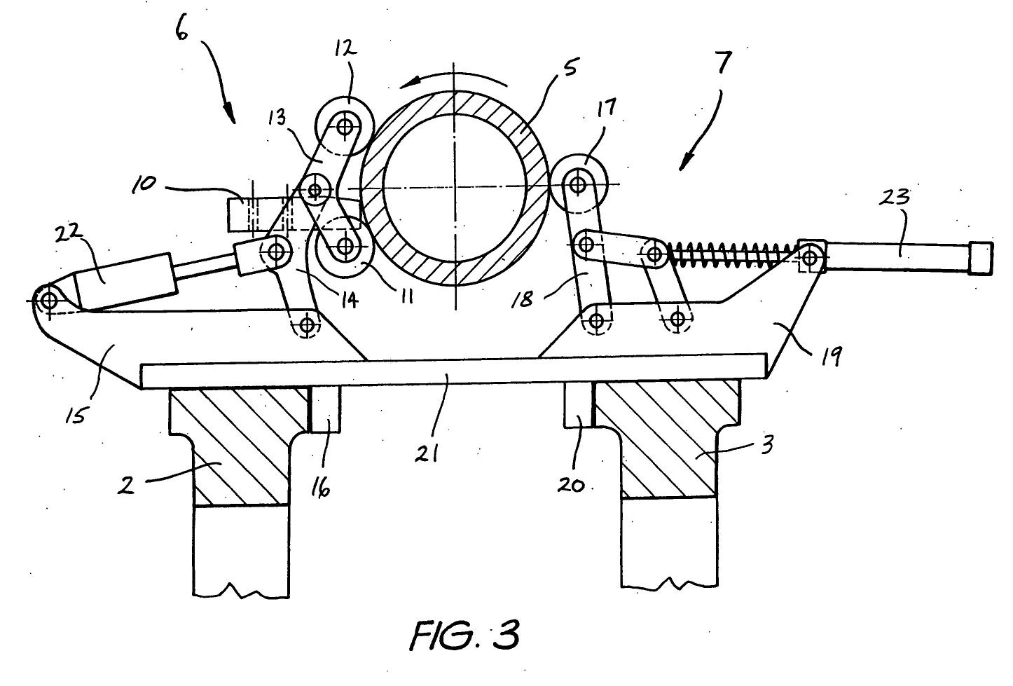

Referring to the drawings, the lathe assembly includes an elongate base 1 incorporating a pair of longitudinally extending rails 2 and 3. Chucks 4 are located respectively at opposite ends of the base. The chucks are longitudinally movable with respect to the base and are configured to engage opposite longitudinal ends of a Fibre Reinforced Cement (FRC) column blank 5, to be profiled. Each chuck is selectively fixably connectable to the base in any one of a plurality of axial locations. As best seen in FIG. 3, two lateral supports in the form of first 6 and second 7 lathe steadies are connected to the base to support the column blank 5 at respective support locations between the chucks 4. Drive means for rotating the column blank about its longitudinal axis are also provided. In the illustrated embodiment, the drive means take the form of a motor and associated gearbox, within housing 8, and disposed to drive the chucks 4 via a suitable arrangement of belts and pulleys. A profiling assembly 9 is connected to the base. This assembly includes a profiling head 10 engageable with an outer circumferential surface of the column blank 5.

The first lathe steady 6 includes two support rollers 11 and 12 having respective axes of rotation parallel to the longitudinal axis of the column blank. The rollers are thereby engageable with the outer circumferential surface of the column blank to provide lateral support for the blank during rotation on the lathe. The support rollers are rotatably mounted to opposite ends of a first bell crank lever 13. The lever 13 has an axis of rotation which is movable but which remains parallel to the longitudinal axis of the column blank throughout its locus of movement. The lever 13 is curved in order that its axis of rotation is offset from the axes of rotation of the associated support rollers 11 and 12. The lever 13 in turn is hingedly connected to a second bell crank lever 14. The lever 14 also has an axis of rotation parallel to the longitudinal axis of the blank. The lever 14 is rotatably connected to a first base plate 15. The first base plate is connected to an engaging formation 16 for retaining the first lathe steady on the rail 2. In this way, the first lathe steady is longitudinally movable along the rail 2.

The second lathe steady 7 includes a single support roller 17 having an axis of rotation parallel to the longitudinal axis of the column blank. The roller 17 is engageable with the outer circumferential surface of the column blank to provide lateral support for the blank during rotation on the lathe, in the diametrically opposing position from the lateral support provided by the first lathe steady. The roller 17 is rotatably mounted on a pivotal arm 18. The arm has a pivot axis parallel to the longitudinal axis of the column blank. The arm in turn is pivotably connected to a second base plate 19. The second base plate is connected to an engaging formation 20 for retaining the second lathe steady on the respective longitudinal rail 3. The second lathe steady is thereby longitudinally slidable along the rail 3. The second lathe steady is fixedly connected to the first lathe steady by a cross-member 21.

A first pneumatic actuator 22 is operable on the second bell crank lever 14 of the first lathe steady to move the respective rollers 11 and 12 into and out of engagement with the column blank. A second pneumatic actuator 23 is operable on the pivotal arm 18 of the second lathe steady to move the respective roller 17 into and out of engagement with the column blank.

In the illustrated embodiment, the support rollers 11 and 12 of the first lathe steady are configured to move generally radially in response to imperfections in the outer circumferential surface of the column blank, thereby to absorb vibration and to provide a smoother finish to the blank. The radial movement of the rollers 11 and 12 is facilitated by the bell-crank configuration of the frame 13. The rotational mounting of the frame also serves to ensure equal distribution of forces between the rollers and the column surface, as any slight misalignment of the rollers is automatically corrected by rotation of the frame.

The profiling assembly 9 is connected to the cross-member 21 adjacent the first lathe steady. The profiling assembly is longitudinally movable along the rail 2. The lathe steadies 6 and 7 and the profiling assembly 9 are driven simultaneously along the rails by a motor and associated gearbox (not shown) located between the rails. A vacuum extractor 24 is connected to the profiling assembly to remove dust and waste material machined from the column blank during the profiling operation.

In use, a FRC column blank 5 to be profiled is supported in the lathe assembly by moving the chucks 4 longitudinally into engagement with opposite longitudinal ends of the column. The lathe steadies 6 and 7 are then brought into laterally supporting contact with the column blank 5 by actuating the respective pneumatic actuators, which in turn move the respective support rollers into diametrically opposing engagement with the outer surface of the column blank. The motor and drive assembly are then activated to rotate the chucks and thereby the blank 5. Next, the profiling head 10 on the profiling assembly is brought into profiling engagement with the outer surface of the column blank 5.

During the profiling operation, the lathe steadies 6 and 7 and the profiling assembly 9 are driven progressively in unison along the rails 2 and 3 by the motor located between the rails (not shown), to profile the outer surface of the blank 5 along all or most of its length. However, it will be appreciated that in alternative embodiments the lathe steadies 2 and 3 and-profiling assembly 9 may be held stationary and the blank 5 may be moved longitudinally by traversing the chucks 4 along the tracks.

The column blank 5 is typically made from a fibre reinforced cement composition that falls generally within the ranges set out in the table below.

| | Acceptable range |
|---|---|
| Dry Ingredients | (% by dry weight) |
| Cement | 15-50% |
| Siliceous material | 25-80% |
| Fibrous material | 0-20% |
| Additives | 0-40% |

Throughout this specification, unless indicated otherwise where there is reference to wt %, all values are with respect to a cement formulation on a dry materials weight basis prior to addition of water and processing.

Preferably, the siliceous material in the formulation is ground sand, also known as silica, or fine quartz. Preferably the siliceous material has an average particle size of 1-50 microns, and more preferably 20-30 microns.

The fibrous materials used in the formulation can include cellulose such as softwood and hardwood cellulose fibres, non wood cellulose fibres, asbestos, mineral wool, steel fibre, synthetic polymers such as polyamides, polyesters, polypropylene, polyacrylonitrile, polyacrylamide, polymethylpentene, viscose, nylon, PVC, PVA, rayon, glass, ceramic or carbon. Cellulose fibres produced by the Kraft process are preferred.

The other additives used in the formulation can be fillers such as mineral oxides, hydroxides and clays, metal oxides and hydroxides, fire retardants such as magnesite, thickeners, silica fume or amorphous silica, colorants, pigments, water sealing agents, water reducing agents, setting rate modifiers, hardeners, filtering aids, plasticisers, dispersants, foaming agents or flocculating agents, water-proofing agents, density modifiers or other processing aids.

The thin walled columns produced on the profiling assembly typically have a post-profiling wall thickness to diameter ratio of less than around 0.050. Thicker walled columns made using prior art methods typically have a wall thickness to diameter ratio of greater than 0.050. As will be appreciated by those skilled in the art, the wall thickness to diameter ratio in columns of this type necessarily varies depending on the outer diameter of the column.

The use of the illustrated profiling assembly allows column wall thicknesses to be reduced by around 5 mm compared with columns produced using prior art methods. It will be appreciated that this reduction in material results in more lightweight columns. Moreover, it is emphasised that this reduction in column weight significantly reduces occupational health and safety (OHS) issues related to the handling of the columns.

While the wall thickness has been reduced, it is noted that the columns produced on the profiling assembly described above are capable still capable of withstanding moderate longitudinal compressive loading and also circumferential tensile loading. In many load-bearing applications, the columns do not require in-fill or additional posts. Moreover, they can be erected on-site without formwork, thereby saving construction time, labour and materials.

It will be appreciated that the maximum tolerable longitudinal compressive load is dependent on the length of the column. However, indicative values for several column lengths are provided below. In terms of tensile strength, it is noted that columns of up to at least 4.5 m in length conform to the relevant standards required to allow for filling with wet concrete. Therefore, in applications where the columns are required to support larger compressive loads, the columns may be filled with concrete.

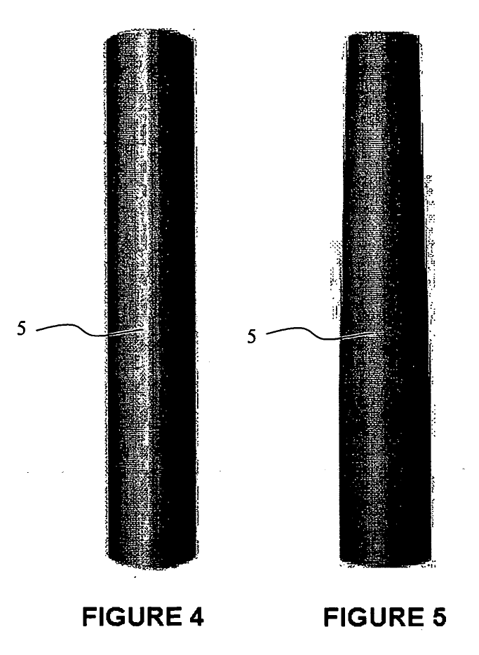

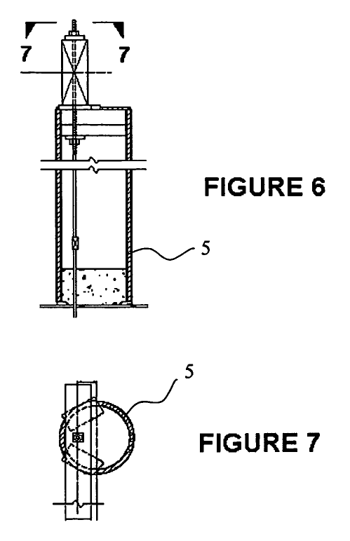

Columns according to the invention can also be made in a variety of shapes, including a “Classic” shape as indicated in FIG. 4 and a “Tapered” shape as indicated in FIG. 5.

Technical information relating to column geometry and material properties is provided in the tables below by way of example only. Unless indicated to the contrary, the data relates to columns manufactured using the profiling assembly described above, on column blanks formed from FRC, using the Hatscheck process.

| | | Inner | Outer | Wall | |
|---|---|---|---|---|---|
| | Length | Diameter | Diameter | Thickness | Weight |
| Column Type | (m) | (mm) | (mm) | (mm) | (kg) |
| Prior Art | 2.75 | 176 | 200 | 12 | 32.7 |
| “Classic” | | | | | |
| column | | | | | |
| Prior Art | 4 | 176 | 200 | 12 | 47.6 |
| “Classic” | | | | | |
| column | | | | | |
| New Lightweight | 2.75 | 176 | 195 | 9.5 | 25.6 |
| “Classic” | | | | | |
| Column | | | | | |
| New Lightweight | 4 | 176 | 195 | 9.5 | 37.2 |
| “Classic” | | | | | |
| Column | | | | | |
| Prior Art | 2.75 | 233 | 260 | 13.5 | 47.3 |
| “Classic” | | | | | |
| column | | | | | |
| Prior Art | 4 | 233 | 260 | 13.5 | 68.8 |
| “Classic” | | | | | |
| column | | | | | |
| New Lightweight | 2.75 | 233 | 250 | 8.5 | 32.2 |
| “Classic” | | | | | |
| Column | | | | | |
| New Lightweight | 4 | 233 | 250 | 8.5 | 46.8 |
| “Classic” | | | | | |
| Column | | | | | |

TABLE 1A
Classic Architectural Columns - No Handrail Loading
Supported Roof Areas & Ultimate Loads − Eₘₐₓ = OD/4 (see FIG. 7)

| OD at top | | B_{MIN} = 35 mm | | | B_{MIN} = 45 mm | | | B_{MIN} = 70 mm | | | B_{MIN} = 90 mm | | |
|---|---|---|---|---|---|---|---|---|---|---|---|---|---|
| of | Column | | Supported Roof | | | Supported Roof | | | Supported Roof | | | Supported Roof | |
| column | Height | Ult Load | Sheet | Tiled | Ult Load | Sheet | Tiled | Ult Load | Sheet | Tiled | Ult Load | Sheet | Tiled |
| (mm) | (mm) | (kN) | Roof | Roof | (kN) | Roof | Roof | (kN) | Roof | Roof | (kN) | Roof | Roof |
| 195 | up to 3000 | 6.8 | 10.1 | 4.3 | 6.8 | 10.1 | 4.3 | 6.8 | 10.1 | 4.3 | 6.8 | 10.1 | 4.3 |
| (176) | 3600 | 5.2 | 7.7 | 3.3 | 5.2 | 7.7 | 3.3 | 5.2 | 7.7 | 3.3 | 5.2 | 7.7 | 3.3 |
| | 4000 | 4.4 | 6.6 | 2.8 | 4.4 | 6.6 | 2.8 | 4.4 | 6.6 | 2.8 | 4.4 | 6.6 | 2.8 |
| 250 | up to 3000 | 10.3 | 15.3 | 6.5 | 10.3 | 15.3 | 6.5 | 10.3 | 15.3 | 6.5 | 10.3 | 15.3 | 6.5 |
| (233) | 3600 | 8.8 | 13.0 | 5.6 | 8.8 | 13.0 | 5.6 | 8.8 | 13.0 | 5.6 | 8.8 | 13.0 | 5.6 |
| | 4000 | 7.6 | 11.3 | 4.8 | 7.6 | 11.3 | 4.8 | 7.6 | 11.3 | 4.8 | 7.6 | 11.3 | 4.8 |
| | 5000 | 5.5 | 8.1 | 3.5 | 5.5 | 8.1 | 3.5 | 5.5 | 8.1 | 3.5 | 5.5 | 8.1 | 3.5 |
| | 6000 | 4.1 | 6.1 | 2.6 | 4.1 | 6.1 | 2.6 | 4.1 | 6.1 | 2.6 | 4.1 | 6.1 | 2.6 |
| 345 | up to 4000 | 27.1 | 40.2 | 17.2 | 32.7 | 48.5 | 20.8 | 32.7 | 48.5 | 20.8 | 32.7 | 48.5 | 20.8 |
| (304) | 5000 | 27.1 | 40.2 | 17.2 | 27.4 | 40.6 | 17.4 | 27.4 | 40.6 | 17.4 | 27.4 | 40.6 | 17.4 |
| | 6000 | 21.3 | 31.6 | 13.5 | 21.3 | 31.6 | 13.5 | 21.3 | 31.6 | 13.5 | 21.3 | 31.6 | 13.5 |
| 425 (380) | up to 6000 | 29.6 | 43.9 | 18.8 | 38.2 | 56.6 | 24.2 | 39.0 | 57.7 | 24.7 | 39.0 | 57.7 | 24.7 |

TABLE 1C
Tapered Architectural Columns - No Handrail Loading
Supported Roof Areas & Ultimate Loads − Eₘₐₓ = OD/4 (see FIG. 7)

| OD at top | | B_{MIN} = 35 mm | | | B_{MIN} = 45 mm | | | B_{MIN} = 70 mm | | | B_{MIN} = 90 mm | | |
|---|---|---|---|---|---|---|---|---|---|---|---|---|---|
| of | Column | | Supported Roof | | | Supported Roof | | | Supported Roof | | | Supported Roof | |
| column | Height | Ult Load | Sheet | Tiled | Ult Load | Sheet | Tiled | Ult Load | Sheet | Tiled | Ult Load | Sheet | Tiled |
| (mm) | (mm) | (kN) | Roof | Roof | (kN) | Roof | Roof | (kN) | Roof | Roof | (kN) | Roof | Roof |
| 195 | up to 3000 | 12.5 | 18.5 | 8.0 | 12.5 | 18.5 | 8.0 | 12.5 | 18.5 | 8.0 | 12.5 | 18.5 | 8.0 |
| (176) | 3600 | 10.7 | 15.8 | 6.8 | 10.7 | 15.8 | 6.8 | 10.7 | 15.8 | 6.8 | 10.7 | 15.8 | 6.8 |
| | 4000 | 9.6 | 14.2 | 6.1 | 9.6 | 14.2 | 6.1 | 9.6 | 14.2 | 6.1 | 9.6 | 14.2 | 6.1 |
| 250 (233) | up to 4000 | 11.2 | 16.6 | 7.1 | 14.5 | 21.5 | 9.2 | 17.3 | 25.6 | 11.0 | 17.3 | 25.6 | 11.0 |
| 345 (304) | up to 4000 | 27.1 | 40.2 | 17.2 | 35.0 | 52.0 | 22.2 | 52.3 | 77.5 | 33.2 | 52.3 | 77.5 | 33.2 |

TABLE 1D
Classic Architectural Columns - Handrail Loading
Supported Roof Areas & Ultimate Loads −Eₘₐₓ = OD/4 (see FIG. 7)

| OD at top | | B_{MIN} = 35 mm | | | B_{MIN} = 45 mm | | | B_{MIN} = 70 mm | | | B_{MIN} = 90 mm | | |
|---|---|---|---|---|---|---|---|---|---|---|---|---|---|
| of | Column | | Supported Roof | | | Supported Roof | | | Supported Roof | | | Supported Roof | |
| column | Height | Ult Load | Sheet | Tiled | Ult Load | Sheet | Tiled | Ult Load | Sheet | Tiled | Ult Load | Sheet | Tiled |
| (mm) | (mm) | (kN) | Roof | Roof | (kN) | Roof | Roof | (kN) | Roof | Roof | (kN) | Roof | Roof |
| 250 | up to 3000 | 6.9 | 10.2 | 4.4 | 8.9 | 10.2 | 4.4 | 6.9 | 10.2 | 4.4 | 6.9 | 10.2 | 4.4 |
| (233) | 3600 | 5.7 | 8.5 | 3.6 | 5.7 | 8.5 | 3.6 | 5.7 | 8.5 | 3.6 | 5.7 | 8.5 | 3.6 |
| | 4000 | 5.1 | 7.6 | 3.2 | 5.1 | 7.6 | 3.2 | 5.1 | 7.6 | 3.2 | 5.1 | 7.6 | 3.2 |
| | 5000 | 4.0 | 5.9 | 2.5 | 4.0 | 5.9 | 2.5 | 4.0 | 5.9 | 2.5 | 4.0 | 5.9 | 2.5 |
| | 6000 | 3.1 | 4.6 | 2.0 | 3.1 | 4.6 | 2.0 | 3.1 | 4.6 | 2.0 | 3.1 | 4.6 | 2.0 |
| 345 | up to 4000 | 27.1 | 40.2 | 17.2 | 32.7 | 48.5 | 20.8 | 32.7 | 48.5 | 20.8 | 32.7 | 48.5 | 20.8 |
| (304) | 5000 | 25.8 | 38.2 | 16.4 | 25.8 | 38.2 | 16.4 | 25.8 | 38.2 | 16.4 | 25.8 | 38.2 | 16.4 |
| | 6000 | 20.3 | 30.1 | 12.9 | 20.3 | 30.1 | 12.9 | 20.3 | 30.1 | 12.9 | 20.3 | 30.1 | 12.9 |
| 425 (380) | up to 6000 | 29.6 | 43.9 | 18.8 | 37.5 | 56.5 | 23.8 | 37.5 | 55.5 | 23.6 | 37.5 | 55.5 | 23.8 |

TABLE 1F
Tapered Architectural Columns - Handrail Loading
Supported Roof Areas & Ultimate Loads − E_{max =} OD/4 (see FIG. 7)

| OD at top | | B_{MIN} = 35 mm | | | B_{MIN} = 45 mm | | | B_{MIN} = 70 mm | | | B_{MIN} = 90 mm | | |
|---|---|---|---|---|---|---|---|---|---|---|---|---|---|
| of | Column | | Supported Roof | | | Supported Roof | | | Supported Roof | | | Supported Roof | |
| column | Height | Ult Load | Sheet | Tiled | Ult Load | Sheet | Tiled | Ult Load | Sheet | Tiled | Ult Load | Sheet | Tiled |
| (mm) | (mm) | (kN) | Roof | Roof | (kN) | Roof | Roof | (kN) | Roof | Roof | (kN) | Roof | Roof |
| 195 | up to 3000 | 5.0 | 7.4 | 3.1 | 5.0 | 7.4 | 3.1 | 5.0 | 7.4 | 3.1 | 5.0 | 7.4 | 3.1 |
| (176) | 3600 | 4.4 | 6.5 | 2.8 | 4.4 | 6.5 | 2.8 | 4.4 | 6.5 | 2.8 | 4.4 | 6.5 | 2.8 |
| | 4000 | 4.0 | 5.9 | 2.5 | 4.0 | 5.9 | 2.5 | 4.0 | 5.9 | 2.5 | 4.0 | 5.9 | 2.5 |
| 250 (233) | up to 4000 | 8.2 | 12.1 | 5.2 | 8.2 | 12.1 | 5.2 | 8.2 | 12.1 | 5.2 | 8.2 | 12.1 | 5.2 |
| 345 (304) | up to 4000 | 27.1 | 40.2 | 17.2 | 35.0 | 51.9 | 22.2 | 47.1 | 69.9 | 29.9 | 47.1 | 69.9 | 29.9 |

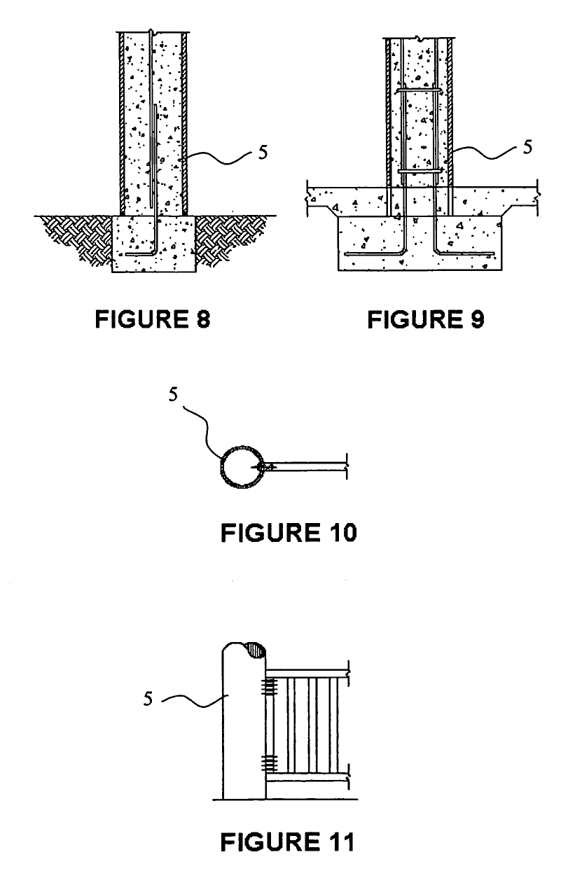

TABLE 2A
Ultimate Axial Compression Capacities (kN) for Pinned Base Footing (see FIG. 8)

| of | Column | E_{MAX} = OD/3 | | | | | E_{MAX} = OD/2 + 50 mm | | | | |
|---|---|---|---|---|---|---|---|---|---|---|---|
| column | Height | One | Three | Three | Four | Four | One | Three | Three | Four | Four |
| (mm) | (mm) | N16 | N12 | N16 | N12 | N16 | N16 | N12 | N16 | N12 | N16 |
| 195 | up to 900 | 66 | 105 | 125 | 115 | 139 | 23 | 37 | 53 | 50 | 64 |
| (176) | 1800 | 23 | 52 | 82 | 75 | 96 | 10 | 22 | 36 | 36 | 49 |
| | 2400 | 13 | 36 | 65 | 6.1 | 79 | 7 | 18 | 30 | 31 | 44 |
| | 3000 | 8 | 27 | 52 | 48 | 65 | 5 | 15 | 25 | 27 | 39 |
| | 3600 | 5 | 20 | 40 | 39 | 54 | 3 | 12 | 22 | 23 | 34 |
| | 4000 | 4 | 17 | 34 | 34 | 48 | 3 | 11 | 20 | 21 | 31 |
| 250 | up to 900 | 119 | 169 | 206 | 188 | 227 | 44 | 56 | 85 | 84 | 111 |
| (233) | 1800 | 65 | 98 | 152 | 145 | 186 | 31 | 42 | 71 | 69 | 97 |
| | 2400 | 51 | 76 | 125 | 124 | 165 | 26 | 36 | 65 | 63 | 90 |
| | 3000 | 41 | 60 | 105 | 106 | 145 | 22 | 31 | 59 | 57 | 84 |
| | 3600 | 33 | 49 | 90 | 91 | 127 | 19 | 27 | 53 | 52 | 77 |
| | 4000 | 28 | 43 | 81 | 82 | 116 | 17 | 25 | 50 | 49 | 73 |
| 345 | up to 1800 | 148 | 199 | 262 | 250 | 314 | 56 | 73 | 107 | 102 | 157 |
| (304) | 2400 | 103 | 128 | 191 | 191 | 270 | 47 | 62 | 95 | 90 | 142 |
| | 3000 | 88 | 110 | 167 | 168 | 249 | 42 | 58 | 89 | 84 | 135 |
| | 3600 | 75 | 99 | 152 | 148 | 228 | 38 | 54 | 85 | 78 | 128 |
| | 4000 | 67 | 86 | 134 | 136 | 214 | 35 | 50 | 79 | 74 | 123 |
| 425 | up to 1800 | 232 | 281 | 362 | 354 | 439 | 77 | 103 | 144 | 134 | 206 |
| (380) | 2400 | 177 | 209 | 274 | 277 | 384 | 68 | 92 | 131 | 121 | 190 |
| | 3000 | 156 | 185 | 248 | 249 | 359 | 63 | 87 | 125 | 115 | 183 |
| | 4000 | 126 | 152 | 207 | 207 | 316 | 56 | 79 | 114 | 104 | 169 |

TABLE 2B
Ultimate Axial Compression Capacities (kN) for Pinned Base Footing (see FIG. 9)

| of | Column | E_{MAX} = OD/3 | | | | | E_{MAX} = OD/2 + 50 mm | | | | |
|---|---|---|---|---|---|---|---|---|---|---|---|
| column | Height | One | Three | Three | Four | Four | One | Three | Three | Four | Four |
| (mm) | (mm) | N16 | N12 | N16 | N12 | N16 | N16 | N12 | N16 | N12 | N16 |
| 195 | up to 900 | 66 | 105 | 25 | 115 | 139 | 23 | 37 | 53 | 50 | 64 |
| (176) | 1800 | 30 | 62 | 91 | 84 | 106 | 13 | 25 | 39 | 39 | 53 |
| | 2400 | 18 | 45 | 74 | 69 | 90 | 9 | 20 | 33 | 34 | 47 |
| | 3000 | 12 | 34 | 61 | 57 | 76 | 6 | 17 | 28 | 30 | 42 |
| | 3600 | 8 | 26 | 50 | 47 | 64 | 5 | 14 | 25 | 26 | 38 |
| | 4000 | 6 | 22 | 43 | 41 | 58 | 4 | 13 | 22 | 24 | 35 |
| 250 | up to 1800 | 74 | 112 | 166 | 155 | 195 | 34 | 45 | 75 | 73 | 100 |
| (233) | 2400 | 59 | 88 | 140 | 136 | 177 | 29 | 39 | 69 | 67 | 94 |
| | 3000 | 48 | 71 | 119 | 120 | 160 | 25 | 35 | 63 | 61 | 89 |
| | 3600 | 40 | 59 | 104 | 105 | 143 | 22 | 31 | 58 | 57 | 83 |
| | 4000 | 35 | 52 | 95 | 96 | 133 | 20 | 29 | 55 | 54 | 79 |
| 345 | up to 2400 | 113 | 141 | 207 | 206 | 281 | 50 | 66 | 98 | 93 | 146 |
| (304) | 3000 | 99 | 123 | 184 | 185 | 264 | 45 | 61 | 93 | 88 | 140 |
| | 3600 | 87 | 108 | 164 | 165 | 247 | 41 | 57 | 88 | 83 | 134 |
| | 4000 | 79 | 99 | 152 | 154 | 235 | 39 | 54 | 85 | 80 | 130 |
| 425 | up to 3000 | 172 | 202 | 269 | 269 | 378 | 67 | 91 | 130 | 119 | 188 |
| (380) | 4000 | 143 | 171 | 231 | 232 | 342 | 60 | 84 | 120 | 111 | 177 |

TABLE 3
Uplift Capacity (kN)

| | | Min. | Ultimate |
|---|---|---|---|
| | | Fixing | Uplift |
| Fixing | Grade | Lap/Embe | Force Per |
| M10 | Grade 250 | 250 | 12 |
| | 4.6/S | 250 | 18 |
| | 8.8/S | 400 | 40 |
| M12 | Grade 250 | 300 | 17 |
| | 4.6/S | 300 | 27 |
| | 8.8/S | 550 | 58 |
| M16 | Grade 250 | 400 | 31 |
| | 4.6/S | 450 | 50 |
| | 8.8/S | 900 | 104 |
| N12 | 500 MPa | 350 | 50 |
| N16 | 500 MPa | 550 | 90 |

TABLE 4
Ultimate Horizontal Capacity (kN) for Fixed Base Footing Only (see FIG. 9)

| OD at top | Column | One | One | | | | | | |
|---|---|---|---|---|---|---|---|---|---|
| of column | Height | M12 | M16 | One | One | Three | Three | Four | Four |
| (mm) | (mm) | 4.6/S MIN | 4.6/S MIN | N12 | N16 | N12 | N16 | N12 | N16 |
| 195 | 600 | 3.0 | 4.7 | 3.5 | 5.0 | 8.0 | 10.5 | 11.5 | 19.3 |
| (176) | 900 | 2.0 | 3.1 | 2.3 | 3.3 | 5.3 | 7.0 | 7.7 | 12.9 |
| | 1800 | 1.0 | 1.6 | 1.2 | 1.7 | 2.7 | 3.5 | 3.8 | 6.4 |
| | 2400 | 0.8 | 1.2 | 0.9 | 1.3 | 2.0 | 2.6 | 2.9 | 4.8 |
| | 3000 | 0.6 | 0.9 | 0.7 | 1.0 | 1.6 | 2.1 | 2.3 | 3.9 |
| | 3600 | 0.5 | 0.8 | 0.6 | 0.8 | 1.3 | 1.8 | 1.9 | 3.2 |
| | 4000 | 0.5 | 0.7 | 0.5 | 0.8 | 1.2 | 1.6 | 1.7 | 2.9 |
| 250 | 600 | 5.0 | 8.5 | 6.0 | 10.0 | 13.2 | 25.0 | 20.8 | 35.0 |
| (233) | 900 | 3.3 | 5.7 | 4.0 | 6.7 | 8.8 | 16.7 | 13.9 | 23.3 |
| | 1800 | 1.7 | 2.8 | 2.0 | 3.3 | 4.4 | 8.3 | 6.9 | 11.7 |
| | 2400 | 1.3 | 2.1 | 1.5 | 2.5 | 3.3 | 6.3 | 5.2 | 8.8 |
| | 3000 | 1.0 | 1.7 | 1.2 | 2.0 | 2.6 | 5.0 | 4.2 | 7.0 |
| | 3600 | 0.8 | 1.4 | 1.0 | 1.7 | 2.2 | 4.2 | 3.5 | 5.8 |
| | 4000 | 0.8 | 1.3 | 0.9 | 1.5 | 2.0 | 3.8 | 3.1 | 5.3 |
| 345 (304) | 600 | 7.3 | 12.7 | 8.8 | 15.5 | 23.3 | 37.7 | 31.0 | 52.2 |
| | 900 | 4.9 | 8.4 | 5.9 | 10.3 | 15.6 | 25.1 | 20.7 | 34.8 |
| | 1800 | 2.4 | 4.2 | 2.9 | 5.2 | 7.8 | 12.6 | 10.3 | 17.4 |
| | 2400 | 1.8 | 3.2 | 2.2 | 3.9 | 5.8 | 9.4 | 7.8 | 13.0 |
| | 3000 | 1.5 | 2.5 | 1.8 | 3.1 | 4.7 | 7.5 | 6.2 | 10.4 |
| | 3600 | 1.2 | 2.1 | 1.5 | 2.6 | 3.9 | 6.3 | 5.2 | 8.7 |
| | 4000 | 1.1 | 1.9 | 1.3 | 2.3 | 3.5 | 5.7 | 4.7 | 7.8 |
| 425 | 600 | 9.7 | 16.8 | 11.8 | 20.8 | 34.7 | 53.8 | 42.3 | 70.8 |
| (380) | 900 | 6.4 | 11.2 | 7.9 | 13.9 | 23.1 | 35.9 | 28.2 | 47.2 |
| | 1800 | 3.2 | 5.6 | 3.9 | 6.9 | 11.6 | 17.9 | 14.1 | 23.6 |
| | 2400 | 2.4 | 4.2 | 3.0 | 5.2 | 8.7 | 13.5 | 10.6 | 17.7 |
| | 3000 | 1.9 | 3.4 | 2.4 | 4.2 | 6.9 | 10.8 | 8.5 | 14.2 |
| | 3600 | 1.6 | 2.8 | 2.0 | 3.5 | 5.8 | 9.0 | 7.1 | 11.8 |
| | 4000 | 1.5 | 2.5 | 1.8 | 3.1 | 5.2 | 8.1 | 6.4 | 10.6 |

It will be appreciated that the illustrated profiling assembly can be used to profile columns having diameters other than those listed in the tables above. It will also be appreciated that the assembly is particularly useful for profiling lightweight FRC columns, as the provision of multiple lateral supports adjacent the position of the profiling tool minimises vibration during profiling. This in turn prevents fracture of the columns near the chucks and also improves the quality of the profiled surface in the finished product. The applicant has also found that the illustrated profiling assembly improves the finished quality of the profiled surface in heavier FRC columns. The columns formed on the profiling assembly have a surface finish conducive to a receiving any one of a variety of coatings, such as paint, render, textured finishes and tiles. In all these respects, the invention represents a practical and commercially significant improvement over the prior art.

Architectural columns produced using the above-described method are suited for use in a variety of applications. For example, they can be placed over electrical or plumbing services to hide the services and thereby enhance the aesthetic properties of a building by giving the impression of a solid marble or concrete column. In addition, the columns can be used in a variety of other load-bearing and non-load-bearing applications.

It will be appreciated by those skilled in the art that while the invention has been described with reference to specific examples, it may also be embodied in many other forms.

1-101. (canceled)

102. A fibre reinforced cement tubular body having a wall thickness to outer diameter ratio of less than around 0.050.

103. The fibre reinforced cement tubular body according to claim 102 wherein an outer circumferential surface of the body is profiled to achieve the wall thickness to outer diameter ratio.

104. The fibre reinforced cement tubular body according to claim 102 wherein at least a portion of the body is profiled on a lathe assembly.

105. The fibre reinforced cement tubular body according to claim 102 wherein the body is formed from a fibre reinforced cement blank manufactured on a mandrel using a Hatschek process.

106. The fibre reinforced cement tubular body according to claim 102 wherein the fibre reinforced cement tubular body is adapted for use as an architectural column.

107. The fibre reinforced cement tubular body according to claim 102 adapted for use selected from the group consisting of a pipe, structural member and concrete forming element.

108. A lathe assembly for forming an elongate tubular body, said lathe assembly comprising:
a base;
at least one chuck located at opposite longitudinal ends of said base, said chucks being configured to engage opposite longitudinal ends of the tubular body;
two or more supports operable to at least partially support the base at two or more support locations between its ends;
a drive operable to rotate the body about a longitudinal axis; and
a profiling tool supported at least partially by the base and engageable to profile an outer circumferential surface of the tubular body.

109. The lathe assembly according to claim 108 wherein two or more of the support locations are spaced circumferentially around the body.

110. The lathe assembly according to claim 108 wherein the supports take the form of support rollers engageable with an outer circumferential surface of the body.

111. The lathe assembly according to claim 110 wherein the support rollers and the profiling tool are adapted to move in unison along the length of the body, so as to remain in their relative axial locations during the profiling operation.

112. The lathe assembly according to claim 110 adapted to move the elongate body longitudinally in relation to the support rollers and the profiling tool, such that the support rollers and the profiling tool remain in their relative axial locations during the profiling operation.

113. The lathe assembly according to claim 110 wherein one or more of the support rollers are independently movable into engagement with the body.

114. The lathe assembly according to claim 108 wherein the body is formed of fibre reinforced cement.

115. The lathe assembly according to claim 108 wherein the tubular body is formed from a fibre reinforced cement blank manufactured on a mandrel using a Hatschek process.

116. The lathe assembly according to claim 108 wherein the tubular body has a wall thickness to outer diameter ratio of less than around 0.050.

117. A method of manufacturing an elongate tubular body, said method comprising:
supporting the body at or adjacent its ends for rotation about a longitudinal axis;
supporting the body laterally at two or more lateral support locations between the ends;
rotating the body about the longitudinal axis; and
profiling an outer surface of the body using a profiling tool.

118. The method according to claim 117 wherein the two or more lateral support locations are located at substantially the same axial position along the length of the body.

119. The method according to claim 117 wherein the two or more lateral support locations are located at different axial positions along the body.

120. The method according to claim 117 wherein lateral support is provided by respective support rollers engageable with an outer circumferential surface of the body.

121. The method according to claim 120 wherein the support rollers and the profiling tool are moved in unison along the length of the body, so as to remain in their relative axial locations during the profiling operation.

122. The method according to claim 120 wherein the elongate body is moved longitudinally in relation to the support rollers and the profiling tool, such that the support rollers and the profiling tool remain in their relative axial locations during the profiling operation.

123. The method according to claim 120 wherein two of the support rollers are independently moved into engagement with the body.

124. The method according to claim 120 wherein two of the support roller are dependently moved into engagement with the body.

125. The method according to claim 120 wherein three of the support rollers are provided, two of the support rollers being movable into engagement with the body independently of the third support roller.

126. The method according claim 120 wherein at least one of the support rollers is configured to move radially in response to imperfections in the outer circumferential surface of the body.

127. The method according to claim 117 wherein the profiling tool when in use is located axially adjacent one of the lateral support locations.

128. The method according to claim 117 wherein the body is formed of fibre reinforced cement.

129. The method according to claim 117 wherein the body is formed from a fibre reinforced cement blank manufactured on a mandrel using a Hatschek process.

130. The method according to claim 117 including the steps of reducing at least in part the initial wall thickness and refining the surface finish of the blank to form the body.

131. The method according to claim 117 wherein the body is profiled to a wall thickness to outer diameter ratio of less than around 0.050.

132. The method according to claim 117 wherein the tubular body is profiled on a lathe assembly.

133. An elongated tubular body manufactured by the method comprising:
supporting the body at or adjacent its ends for rotation about a longitudinal axis;
supporting the body laterally at two or more lateral support locations between the ends;
rotating the body about the longitudinal axis; and profiling an outer surface of the body using a profiling tool.

134. The elongated tubular body of claim 133 wherein the tubular body is formed of fibre reinforced cement.

135. The elongated tubular body of claim 133, wherein the tubular body is formed from a fibre reinforced cement blank and the blank is manufactured on a mandrel using a Hatscek process.

136. The elongate tubular body of claim 133, wherein the tubular body has a wall thickness to outer diameter ratio of less than around 0.050.
